(19) United States
(12) Patent Application Publication
(10) Pub. No.: US 2015/0379915 A1
(43) Pub. Date: Dec. 31, 2015

(54) METHOD FOR PROCESSING INFORMATION AND ELECTRONIC DEVICE

(71) Applicant: Lenovo (Beijing) Co., Ltd., Beijing (CN)

(72) Inventors: Nan LIN, Beijing (CN); Cheng WANG, Beijing (CN)

(73) Assignee: LENOVO (BEIJING) CO., LTD., Beijing (CN)

(21) Appl. No.: 14/586,363

(22) Filed: Dec. 30, 2014

(30) Foreign Application Priority Data
Jun. 27, 2014 (CN) 201410302609.4
Jul. 14, 2014 (CN) 201410333276.1
Jul. 14, 2014 (CN) 201410333672.4

(51) Int. Cl. G09G 3/20

(52) U.S. Cl. CPC G09G 3/2007; G09G 2320/0686; G09G 2340/14

(57) ABSTRACT

A method for processing information and an electronic device are provided. The method includes: receiving a first operation performed on the electronic device by a user; determining whether the first operation meets a first preset condition; and performing a corresponding operation according to the first operation, in the case that the first operation meets the first preset condition.

### CROSS-REFERENCES TO RELATED APPLICATIONS

The present application claims the priority to Chinese Patent Application No. 201410302609.4, entitled “METHOD FOR PROCESSING INFORMATION AND ELECTRONIC DEVICE”, filed with the Chinese State Intellectual Property Office on Jun. 27, 2014, the priority to Chinese Patent Application No. 201410333672.4, entitled “DISPLAY METHOD AND ELECTRONIC DEVICE”, field with the Chinese State Intellectual Property Office on Jul. 14, 2014, and the priority to Chinese Patent Application No. 201410333276.1, entitled “METHOD FOR ACQUIRING IMAGE AND ELECTRONIC DEVICE”, field with the Chinese State Intellectual Property Office on Jul. 14, 2014, which are incorporated herein by reference in their entireties.

### FIELD

The disclosure relates to the field of the computer technology, and in particular to a method for processing information and an electronic device.

### BACKGROUND

With the continuous development of the science and technology, the electronic technology also develops fast, electronic products have more and more types, and people enjoy various conveniences brought by the development of the science and technology. Presently people may enjoy a comfortable life brought by the development of the science and technology via various types of electronic devices. For example, an electronic device for example a mobile phone has become an essential part of people's life, and people may strengthen contact with other persons by calling, sending a short message etc. via the electronic device for example the mobile phone.

In the conventional technology, if a user wants to watch information in the mobile phone, for example time or an unread short message, generally a screen of the mobile phone needs to be lightened, and the user may watch when the screen is lightened. In this case, for the electronic device, power consumption is high since the whole screen is lightened.

### SUMMARY

A method for processing information and an electronic device are provided according to the embodiments of the disclosure, to solve a technical problem in the conventional technology.

A method for processing information applicable to an electronic device, including:
receiving a first operation performed on the electronic device by a user; πdetermining whether the first operation meets a first preset condition; and
performing a corresponding operation according to the first operation, in the case that the first operation meets the first preset condition.

Optionally, wherein in the case that a display unit of the electronic device is in a deactive state, performing a corresponding operation according to the first operation, in the case that the first operation meets the first preset condition, includes:
controlling a first display region of the display unit to display first display content, in the case that the first operation meets the first preset condition, wherein the first display content is configured to indicate an event to be processed and related to the electronic device, and an area of the first display region is less than an area of a display region of the display unit.

Optionally, the method further includes: controlling remaining region of the display region of the display unit to be in the deactive state when or after the controlling a first display region of the display unit to display the first display content.

Optionally, determining whether the first operation meets a first preset condition includes: determining whether operational information corresponding to the first operation matches at least one piece of preset operational information stored in the electronic device; and it is indicated that that the first operation meets the first preset condition if the operational information matches the at least one piece of preset operational information.

Optimally, after controlling a first display region of the display unit to display first display content, the method further includes:
determining whether the displayed first display content meets a second preset condition; and
controlling the electronic device to vibrate and/or controlling the electronic device to ring, in the case that the displayed first display content meets the second preset condition.

Optimally, determining whether the displayed first display content meets a second preset condition includes:
determining whether the number of the events to be processed comprised in the first display content is greater than a preset number; and it is indicated that the first display content meets the second preset condition if the number of the events to be processed comprised in the first display content is greater than the preset number; or
determining whether any one of the events to be processed comprised in the first display content is an event to be processed having an interval between its occurring time instant and a current time instant less than a preset duration; and it is indicated that the event to be processed meets the second preset condition, if any one of the events to be processed comprised in the first display content is the event to be processed.

Optionally, in the case that a display unit of the electronic device is in a deactive state, controlling the electronic device to perform a corresponding operation according to the first operation, in the case that the first operation meets the first preset condition, includes:
controlling an image acquisition unit of the electronic device to acquire an image in the case that the first operation meets the first preset condition.

Optionally, before receiving the first operation performed on the electronic device by the user, the method further includes:
performing detection to determine that a posture of the electronic device changes from a first posture to a second posture; and determining whether change information corresponding to the change from the first posture to the second posture meets preset change information.

Optionally, determining whether the first operation meets the first preset condition includes:
determining, in response to the first operation, whether the first operation meets the first preset condition, in the case that the change information meets the preset change information.

Optimally, in the case that the electronic device comprises a sensing unit,
receiving a first operation performed on the electronic device by a user includes: receiving an operation performed on the sensing unit located at a first position of the electronic device by the user;
determining whether the first operation meets a first preset condition includes: determining a first component in the electronic device where a relation between the first position and the first component meets a preset condition; and
controlling the electronic device to perform a corresponding operation according to the first operation includes: controlling the first component to perform the corresponding operation.

Optionally, determining a first component in the electronic device where a relation between the first position and the first component meets a preset condition includes:
determining the first component located at a second position in the electronic device, wherein a distance between the first position and the second position is less than a preset distance.

An electronic device including one or more processors and having instructions stored thereon, the instructions, when executed by the one or more processors, cause the processors to perform operations including:
receiving a first operation performed on the electronic device by a user;
determining whether the first operation meets a first preset condition; and
performing a corresponding operation according to the first operation, in the case that the first operation meets the first preset condition.

Optionally, in the case that a display unit of the electronic device is in a deactive state, the processors performing operations including:
controlling a first display region of the display unit to display first display content, in the case that the first operation meets the first preset condition, wherein the first display content is configured to indicate an event to be processed and related to the electronic device, and an area of the first display region is less than an area of a display region of the display unit.

Optionally, the processors further perform operation including:
controlling remaining region of the display region of the display unit to be in the deactive state when or after the controlling a first display region of the display unit to display the first display content.

Optionally, wherein in the case that a display unit of the electronic device is in a deactive state, the processors performing operations including:
controlling an image acquisition unit of the electronic device to acquire an image in the case that the first operation meets the first preset condition.

Optionally, the processors further perform the operation including:
performing detection to determine that a posture of the electronic device changes from a first posture to a second posture; and determining whether change information corresponding to the change from the first posture to the second posture meets preset change information.

Optionally, the processor perform operations including:
determining, in response to the first operation, whether the first operation meets the first preset condition, in the case that the change information meets the preset change information.

Optionally, in the case that the electronic device comprises a sensing unit, the processors perform operations including:
receiving an operation performed on the sensing unit located at a first position of the electronic device by the user;
determining a first component in the electronic device where a relation between the first position and the first component meets a preset condition and
controlling the first component to perform the corresponding operation.

### BRIEF DESCRIPTION OF THE DRAWINGS

FIG. 1 is a flowchart of a method for processing information according to an embodiment of the disclosure;

FIG. 2 is a flowchart of a method for processing information according to an embodiment of the disclosure;

FIG. 3 is a schematic diagram of a first display region of an electronic device according to an embodiment of the disclosure;

FIG. 4 is a schematic diagram of a first display region and a second display region of an electronic device according to an embodiment of the disclosure;

FIG. 5 is a structural block diagram of an electronic device according to an embodiment of the disclosure;

FIG. 6 is a flowchart of a method for processing information according to an embodiment of the disclosure;

FIG. 7 is a structural block diagram of an electronic device according to an embodiment of the disclosure;

FIG. 8 is a flowchart of a method for processing information according to an embodiment of the disclosure;

FIG. 9 is a structural block diagram of an electronic device, in the case that the electronic device is a mobile phone, according to an embodiment of the disclosure; and

FIG. 10 is a structural block diagram of an electronic device according to an embodiment of the disclosure.

### DETAILED DESCRIPTION OF THE EMBODIMENTS

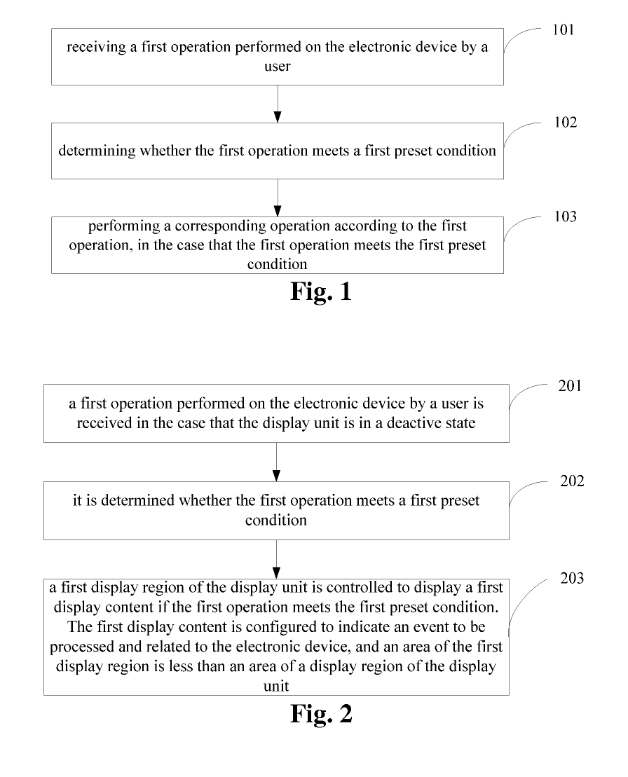

A method for processing information is provided according to an embodiment of the disclosure. The method is applicable to an electronic device, as shown in FIG. 1, the method may include step 101 to 103.

Step 101 includes receiving a first operation performed on the electronic device by a user.

Step 102 includes determining whether the first operation meets a first preset condition.

Step 103 includes performing a corresponding operation according to the first operation, in the case that the first operation meets the first preset condition.

A displaying method is provided according to an embodiment of the disclosure. The method is applicable to an electronic device including a display unit, and the method may include: receiving a first operation performed on the electronic device by a user in the case that the display unit is in a deactive state; determining whether the first operation meets a first preset condition; controlling a first display region of the display unit to display a first display content if the first operation meets the first preset condition, where the first display content is configured to indicate an event to be processed and related to the electronic device, and an area of the first display region is less than an area of a display region of the display unit.

In the embodiments of the disclosure, in the case that the display unit is in the deactive state, the first display region may be controlled to display the first display content if the first operation from the user is received and the first operation meets the preset condition; for example, if the user wants to view information in a mobile phone for example time or an unread short message, the first operation may be performed on the electronic device, the display unit may display information which the user wants to view and the display unit displays the first display content in the first display region, where the area of the first display region is less than the area of the display region of the display unit; hence it does not need to lighten the whole display screen, that is to say, a part of the display screen is lightened, remaining region on the display screen continue to be in the deactive state; in this case, compared with the solution requiring to lighten the whole display screen, the power consumption of the electronic device is reduced and the service life of the electronic device is extended apparently according to the solutions of the embodiments of the disclosure.

In order to illustrate the objects, the technical solutions and advantages of the embodiments of the disclosure more clearly, hereinafter the technical solutions of the embodiments of the disclosure are described clearly and completely in conjunction with the drawings of the embodiments of the disclosure. Apparently, the described embodiments are some of the embodiments of the disclosure, not all the embodiments. All of other embodiments obtained based on the embodiments of the disclosure by those skilled in the art without any creative work fall within the scope of protection of the disclosure.

In the embodiments of the disclosure, the electronic device may be a mobile phone, a tablet computer, a personal computer, a smart TV, a camera and so on, which is not limited in the disclosure.

In addition, a term “and/or” herein is an association for describing associated objects and may indicate three types of relations. For example, A and/or B may indicate that: A exists, both A and B exist, or B exists. In addition, a character “/” herein generally indicates a relation of “or” between the prior object and the latter object associated with each other, unless particularly illustrated.

Hereinafter an embodiment of the disclosure is illustrated in detail in conjunction with the drawings.

Referring to FIG. 2, a displaying method is provided according to an embodiment of the disclosure, applicable to an electronic device including a display unit. The method includes step 201 to step 203.

In step 201, a first operation performed on the electronic device by a user is received in the case that the display unit is in a deactive state.

In the embodiment of the disclosure, in the case that the display unit is in the deactive state, the user may perform the first operation to the electronic device if the user wants to view contents in the electronic device.

In the embodiment of the disclosure, the first operation is not limited.

For example, the electronic device may have a preset key which may be a physical key or a virtual key. An operation for pressing the key by the user may be regarded as the first operation performed by the user.

Alternatively, the first operation is a gesture operation.

Alternatively, the first operation is a sound-controlled operation, i.e., an operation performed by sound.

Alternatively, the first operation is a clicking operation performed on the display unit. The number of the clicking is not limited in the embodiments of the disclosure, the clicking may be for example a click, a double-click or a triple-click. If the first operation is a clicking operation performed on the display unit, the first operation may be a clicking operation performed within a fixed region on the display unit, i.e., the fixed region is preset on the display unit, and the user may operate within the fixed region; or the first operation may also be a clicking operation performed at any position on the display unit.

Alternatively, the first operation is a sliding operation performed on the display unit. Similarly, if the first operation is a sliding operation performed on the display unit, the first operation may be a sliding operation performed within a fixed region on the display unit, i.e., the fixed region is preset on the display unit, and the user may operate within the fixed region; or the first operation may also be a sliding operation performed at any position on the display unit.

In step 202, it is determined whether the first operation meets a first preset condition.

After the first operation performed by the user is received, it may be determined whether the first operation meets the preset condition.

Optionally, in an embodiment of the disclosure, the process of determining whether the first operation meets a first preset condition may include that: it is determined whether operational information corresponding to the first operation matches at least one piece of preset operational information stored in the electronic device; and the first operation meets the first preset condition if the operational information matches the at least one piece of preset operational information.

Optionally, in an embodiment of the disclosure, the process of determining whether operational information corresponding to the first operation matches at least one piece of preset operational information stored in the electronic device may include that:
it is determined whether gesture information corresponding to the first operation matches at least one piece of preset gesture information stored in the electronic device, if the first operation is a gesture operation;
it is determined whether sound information corresponding to the first operation matches at least one piece of preset sound information stored in the electronic device, if the first operation is a sound-controlled operation.; or
it is determined whether clicking information corresponding to the first operation matches at least one piece of preset clicking information stored in the electronic device, if the first operation is a clicking operation performed on the display unit.

In the embodiments of the disclosure, the at least one piece of preset gesture information may be stored in the electronic device in advance; if gesture information corresponding to the gesture operation performed by the user can match one of the at least one piece of preset gesture information, it is indicated that the first operation meets the first preset condition.

Alternatively, in the embodiments of the disclosure, the at least one piece of preset sound information may be stored in the electronic device in advance; if sound information corresponding to the sound-controlled operation performed by the user matches one of the at least piece of preset sound information, it is indicated that the first operation meets the first preset condition. In an embodiment of the disclosure, two pieces of sound information being matched may indicate that contents of text information corresponding to the two pieces of sound information are matched, for example the contents of text information corresponding to the two pieces of sound information are same. Alternatively, twp pieces of sound information being matched may also include that voiceprint features of the two pieces of sound information are matched for example the voiceprint features of the two pieces of sound information are same, besides including that the contents of text information corresponding to the two pieces of sound information are matched; in this way, it may be ensured that the electronic device responds in the case that an owner of the electronic device performs the first operation to the electronic device, thereby protecting privacy.

Alternatively, in the embodiments of the disclosure, the at least one piece of preset clicking information may be stored in the electronic device in advance; if clicking information corresponding to the clicking operation performed by the user matches one of the at least one piece of preset clicking information, it is indicated that the first operation meets the first preset condition. In an embodiment of the disclosure, two pieces of clicking information being matched may indicate that the numbers of clicking and clicking frequencies corresponding to the two pieces of clicking information are matched, for example clicking twice with a same frequency indicates that the two pieces of clicking information are matched. Alternatively, two pieces of clicking information being matched may further include that positions corresponding to the two pieces of clicking information are matched for example positions corresponding to the two pieces of clicking information are same, besides including that the numbers of clicking and clicking frequencies corresponding to the two pieces of clicking information are matched. The at least piece of preset clicking information may be set by the electronic device itself or by the user. If the at least piece of clicking information is set by the user, generally it is set by the owner of the electronic device; the owner of the electronic device certainly know where a preset position is located and the preset position is unknown for other users; although other users may also perform a clicking operation, the electronic device also determines that the operation performed by other users does not meet the first preset condition, and the subsequent operations will not be performed, thereby protecting the privacy of the owner of the electronic device.

In step 203, a first display region of the display unit is controlled to display a first display content if the first operation meets the first preset condition. The first display content is configured to indicate an event to be processed and related to the electronic device, and an area of the first display region is less than an area of a display region of the display unit.

In the embodiments of the disclosure, the first display region may be a display region preset in the electronic device, i.e., a position of the first display region may be fixed in the display unit; or the first display region may also be a display region randomly selected by the electronic device, i.e., the position of the first display region may not be fixed in the display unit.

In the embodiments of the disclosure, if the first operation meets the first preset condition, the electronic device may control the first display region to display the first display content. The first display content being configured to indicate an event to be processed and related to the electronic device may refer to that the first display content includes at least one event to be processed in the electronic device. The area of the first display region is less than the area of the display region, i.e., the first display region is a part of the display region the display unit; the part of the display region of the display unit is started to display the first display content, thereby the user is not influenced to watch corresponding information, and power of the electronic device may also be saved.

Furthermore, in an embodiment of the disclosure, the method may further include that: display regions other than the first display region in the display region of the display unit are controlled to be still in the deactive state, when or after the first display region of the display unit is controlled to display the first display content.

That is to say, when or after the first display region is controlled to display the first display content, the remaining region on the display is controlled to be still in the deactive state, thereby saving power.

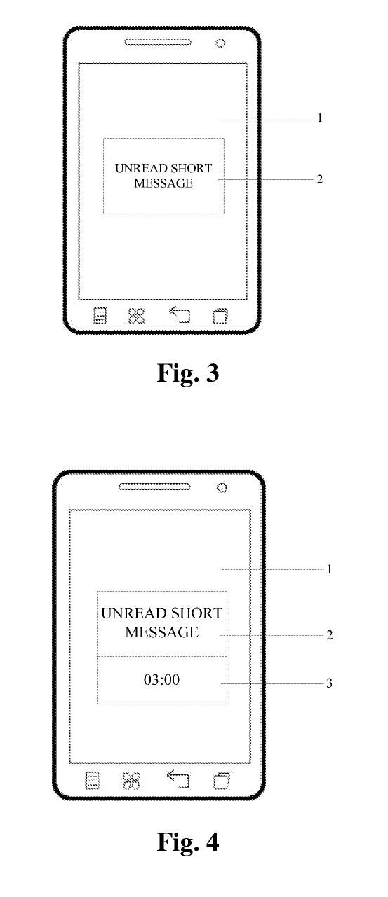

Reference is made to FIG. 3 which is a schematic diagram of an electronic device. In FIG. 3, the electronic device is a mobile phone. In FIG. 3, 1 indicates the display unit, and 2 indicates the first display region. It may be seen from FIG. 3 that, a sentence of “an unread short message” is displayed in the first display region, which is an event to be processed; and an area of the first display region, i.e., an area of a block indicated by 2, is apparently less than an area of a display region of the display unit. In the embodiment, in order to illustrate that which region is the first display region, a border is added to the first display region; but in practice, the first display region may not have the border.

Furthermore, in an embodiment of the disclosure, the method may further include that: a second display region of the display unit is controlled to display time information when or after the first display region of the display unit is controlled to display the first display content. A sum of the area of the first display region and an area of the second display region is less than the area of the display region of the display unit.

Similarly, in the embodiment of the disclosure, the second display region may be a display region preset in the electronic device, i.e., a position of the second display region may be fixed in the display unit; or the second display region may be display region randomly selected by the electronic device, i.e., the position of the second display region may be not fixed in the display unit.

Reference is made to FIG. 4 which is a schematic diagram of an electronic device. In FIG. 4, the electronic device is also a mobile phone. In FIG. 4, 1 indicates the display unit, 2 indicates the first display region, and 3 indicates the second display region. It may be seen from FIG. 4 that, a sentence of “an unread short message” is displayed in the first display region, which is an event to be processed, and an area of the first display region is an area of a block indicated by 2. A character “03:00” is displayed in the second display region, which is time information, and an area of the second display region is an area of a block indicated by 3. Apparently, a sum of an area of the first display region and an area of the second display region is less than an area of a display region of the display unit. In the embodiment, in order to clearly illustrate which regions are the first display region and the second display region respectively, a border is added to both the first display region and the second display region, but in practice, the first display region and the second display region may not have the border. In addition, in FIG. 4, the first display region and the second display region are shown as adjacent regions, but in the specific implementation of the embodiment of the disclosure, the first display region may be adjacent to the second display region or not.

Optionally, in the embodiment of the disclosure, the method may further include that: the remaining region of the display unit are controlled to be still in the deactive state, when or after the second display region of the display unit is controlled to display time information.

That is to say, after the user performs the first operation, the display unit is also controlled to display the time information besides displaying the first display content, if it is determined that the first operation meets the first preset condition. In this case, the user may also view the current time besides watching some contents to be processed to know whether information to be processed exists in a timely manner. A sum of the area of the first display region and the area of the second display region is less than the area of the display region of the display unit, i.e., the first display content and the time information are displayed in parts of the display region of the display unit, and display regions other than the first display region and the second display region may be still in the deactive state, thereby saving power as much as possible.

Optionally, in an embodiment of the disclosure, the method may further include that: the electronic device is controlled to broadcast time when or after the second display region of the display unit is controlled to display the time information.

That is to say, the electronic device may also be controlled to broadcast time besides displaying the time information. A certain user may view one piece of content at a time instant; while if the first display content and the time information are displayed simultaneously, the user may view the first display content firstly, and ignore the time information. Hence, if the electronic device is controlled to broadcast time simultaneously, the user may watch the first display content and listen to the time information simultaneously.

Furthermore, in an embodiment of the disclosure, the g method may further include that: it is determined whether the displayed first display content meets a second preset condition, when or after the first display region of the display unit is controlled to display the first display content; and the electronic device is controlled to vibrate and/or ring if the displayed first display content meets the second preset condition.

That is to say, if the first display content meets the second preset condition, the first display content may be considered as a piece of content to be prompted for the user. In this case, the electronic device may be controlled to vibrate and/or ring to prompt the user.

Optionally, in the embodiment of the disclosure, the process of determining whether the displayed first display content meets a second preset condition may include that:
it is determined whether the number of the events to be processed included in the first display content is greater than a preset number; and the first display content meets the second preset condition, if the number of the events to be processed included in the first display content is greater than the preset number; or
it is determined whether any one of the events to be processed included in the first display content is an event to be processed having an interval between its occurring time instant and a current time instant less than a preset duration; and the event to be processed meets the second preset condition if any one of the events to be processed included in the first display content is the event to be processed.

If the number of the events to be processed is greater than the preset number, it is determined that it needs to prompt the user to process. Alternatively, if some of the events to be processed are just received, it needs to prompt the user to watch in a timely manner.

In the case that the user performs the first operation to the electronic device, although the first display content is displayed on the first display region, the user does not view the first display content in a timely manner, the electronic device may determine whether to prompt the user based on the performance of the events to be processed included in the first display content.

For example, if the first operation is a gesture operation, the user may perform the gesture operation inadvertently; after the first operation, the first display content is displayed on the first display region of the display unit, but the user may not view the display unit, hence the user may miss some events to be processed, particularly some events to be processed in a timely manner. In this case, the electronic device may be controlled to determine whether to prompt the user based on the performance of the events to be processed included in the first display content. For example, if the number of the events to be processed is great and some of the events to be processed may be significant, it may need to prompt the user to process as soon as possible. Alternatively, if the event to be processed has a short time interval between its receiving time instant and a current time instant, it may need to prompt the user to process in a timely manner; since some events to be processed have a certain timeliness, some loss will occur if the events to be processed are not processed in a timely manner.

In summary, according to the process way of the embodiments of the disclosure, a part of the display region of the display unit displays some contents to be viewed for the user, which can save power; in addition, the user may be prompted to avoid missing some significant information, hence the electronic device has a strong ability for processing information. The intelligence of the electronic device is improved significantly according to the technical solutions of the embodiments of the disclosure.

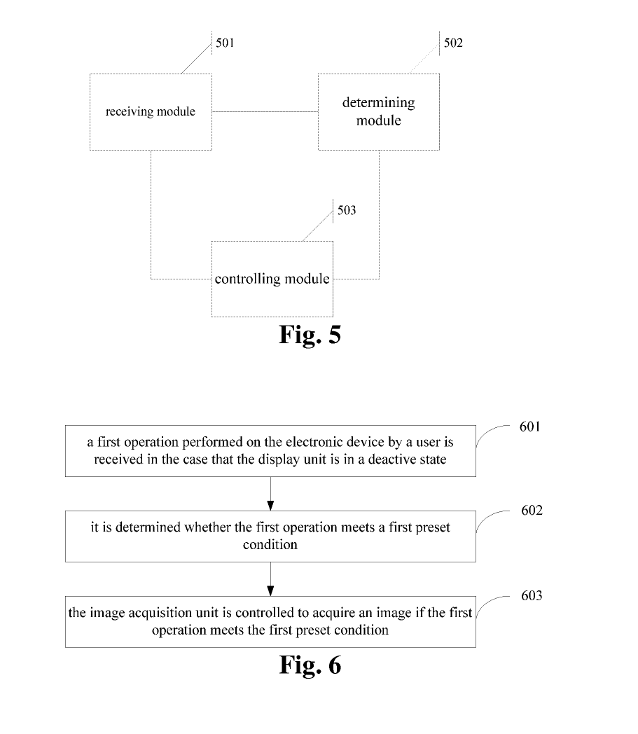

Referring to FIG. 5, based on the same concept, an electronic device including a display unit is provided according to an embodiment of the disclosure. The electronic device may further include a receiving module 501, a determining module 502 and a controlling module 403.

The receiving module 501 is configured to receive a first operation performed on the electronic device by a user in the case that the display unit is in a deactive state.

The determining module 502 is configured to determine whether the first operation meets a first preset condition.

The controlling module 503 is configured to control a first display region of the display unit to display a first display content if the first operation meets the first preset condition. The first display content is configured to indicate an event to processed and related to the electronic device, and an area of the first display region is less than an area of a display region of the display unit.

Optionally, in an embodiment of the disclosure, the controlling module 503 is further configured to control display regions other than the first display region in the display region of the display unit to be still in the deactive state, when or after controlling the first display region of the display unit to display the first display content.

Optionally, in an embodiment of the disclosure, the judging module 502 is configured to determine whether operational information corresponding to the first operation matches at least one piece of preset operational information stored in the electronic device; and the determining module 502 is configured to determine that the first operation meets the first preset condition if the operational information matches the at least one piece of preset operational information.

Optionally, in an embodiment of the disclosure, the determining module 502 is configured to determine whether gesture information corresponding to the first operation matches at least one piece of preset gesture information stored in the electronic device if the first operation is a gesture operation; determine whether sound information corresponding to the first operation matches at least one piece of preset sound information stored in the electronic device if the first operation is a sound-controlled operation; or determine whether clicking information corresponding to the first operation matches at least one piece of preset clicking information stored in the electronic device if the first operation is a clicking operation performed on the display unit.

Optionally, in an embodiment of the disclosure, the controlling module 503 is further configured to control a second display region of the display unit to display time information when or after controlling the first display region of the display unit to display the first display content. A sum of the area of the first display region and an area of the second display region is less than the area of the display region of the display unit.

Optionally, in an embodiment of the disclosure, the controlling module 503 is further configured to control the electronic device to broadcast time when or after controlling the second display region of the display unit to display the time information.

Optionally, in an embodiment of the disclosure, the judging module 502 is further configured to determine whether the displayed first display content meets a second preset condition, when or after the controlling module 503 controls the first display region of the display unit to display the first display content. The controlling module 503 is further configured to control the electronic device to vibrate and/or ring if the displayed first display content meets the second preset condition.

Optionally, in an embodiment of the disclosure, the determining module 502 is further configured to determine whether the number of the events to be processed included in the first display content is greater than a preset number, and the first display content meets the second preset condition if the number of the events to be processed included in the first display content is greater than the preset number; or determine whether any one of the events to be processed included in the first display content is an event to be processed having an interval between its occurring time instant and a current time instant less than a preset duration, and the event to be processed meets the second preset condition if any one of the events to be processed included in the first display content is the event to be processed.

According to the embodiments of the disclosure, a displaying method applicable to an electronic device including a display unit is provided. The method may include: receiving a first operation performed on the electronic device by a user in the case that the display unit is in a deactive state; determining whether the first operation meets a first preset condition; controlling a first display region of the display unit to display a first display content if the first operation meets the first preset condition, where the first display content is configured to indicate an event to be processed and related to the electronic device, and an area of the first display region is less than an area of a display region of the display unit.

In the embodiments of the disclosure, in the case that the display unit is in the deactive state, the first display region may be controlled to display the first display content if the first operation from the user is received and the first operation meets the preset condition; for example, if the user wants to view information in a mobile phone for example time or an unread short message, the first operation may be performed on the electronic device, the display unit may display information which the user wants to watch and the display unit displays the first display content in the first display region, where the area of the first display region is less than the area of the display region of the display unit; hence it does not need to lighten the whole display screen, that is to say, a part of the display screen is lightened, display regions other than the first display region continue to be in the black screen state; in this case, compared with the solution requiring to lighten the whole display screen, the power consumption of the electronic device is reduced and the service life of the electronic device is extended apparently according to the solutions of the embodiments of the disclosure.

Those skilled in the art should clearly know that the dividing for each functional module above is exemplary for convenience and conciseness. In practice, the above functions may be performed by different functional modules based on the requirement, i.e., the apparatus includes different functional modules to perform all or part of the functions described above. For the specific working process of the system, apparatus and unit described above, one may refer to a corresponding process in the preceding method embodiments, which is not described here.

In the several embodiments provided by the disclosure, it should be understood that the disclosed system, apparatus or method may be implemented by other ways. For example, the apparatus embodiments described above are schematic, the dividing for the module or the unit is based on the logical function; in practice, the module or the unit may be divided by other ways, for example multiple units or assemblies may be combined or integrated into another system, or some features may be ignored or not executed. In addition, the displayed or discussed coupling, direct coupling or communication connection may be through some interfaces, and indirect coupling or communication connection of the apparatus or unit may be electric or mechanical or the like.

Units illustrated as a separate component may be physical separated or not. A component displayed as a unit may be a physical unit or not, i.e., locating at the same location or distributing on multiple network units. Part or all of the units may be selected to realize the objects of the embodiments based on the actual requirement.

In addition, various functional units of each embodiment of the disclosure may be integrated in a processing unit, may be separated physical units or two or more units may be integrated in one unit. The integrated unit above may be implemented by hardware or a software functional unit.

In the case that the integrate unit is implemented as the software functional unit or sold or used as an independent product, the integrated unit may be stored in a computer readable storing medium. Based on such understanding, the essential parts, parts contributing to the conventional technology or part or all of the technical solutions of the disclosure may be embodied as a software product. The computer software product is stored in a storage medium and includes several instructions configured to enable a computer device (which may be personal computer, a server, or a network device or the like) or a processor to perform all of part of the steps in the methods of each embodiment of the disclosure. The preceding medium includes a USB flash disc, a mobile disc, a Read-Only Memory (ROM), a Random Access Memory (RAM), a magnetic disc or a CD-ROM or the like.

Specifically, computer program instructions corresponding to a method for processing information in the embodiment of the disclosure may be stored in a storage medium for example a CD-ROM, a hard disc or a USB flash disc. When computer program instructions corresponding to a displaying method stored in the storage medium are read or executed by an electronic device, including:
receiving a first operation performed on the electronic device by a user in the case that the display unit is in a deactive state;
determining whether the first operation meets a first preset condition; and
controlling a first display region of the display unit to display a first display content if the first operation meets the first preset condition, where the first display content is configured to indicate an event to be processed and related to the electronic device, and an area of the first display region is less than an area of a display region of the display unit.

Optionally, when or after computer instructions stored in the storage medium and corresponding to the controlling the first display region of the display unit to display the first display content are executed, further including:
controlling displaying regions other than the first display region in the display region of the display unit to be still in the deactive state.

Optionally, when computer instructions stored in the storage medium and corresponding to the determining whether the first operation meets a first preset condition are executed, including:
determining whether operational information corresponding to the first operation matches at least one piece of preset operational information stored in the electronic device; and the first operation meets the first preset condition if the operational information matches the at least one piece of preset operational information.

Optionally, when computer instructions stored in the storage medium and corresponding to the determining whether operational information corresponding to the first operation matches at least one piece of preset operational information stored in the electronic device are executed, including:
determining whether gesture information corresponding to the first operation matches at least one piece of preset gesture information stored in the electronic device if the first operation is a gesture operation; or
determining whether sound information corresponding to the first operation matches at least one piece of preset sound information stored in the electronic device if the first operation is a sound-controlled operation; or
determining clicking information corresponding to the first operation matches at least one piece of preset clicking information stored in the electronic device if the first operation is a clicking operation performed on the display unit.

Optionally, when or after computer instructions stored in the storage medium and corresponding to the controlling a first display region of the display unit to display a first display content are executed, further including:
controlling a second display region of the display unit to display time information, where a sum of the area of the first display region and an area of the second display region is less than the area of the display region of the display unit.

Optionally, when or after computer instructions stored in the storage medium and corresponding to the controlling a second display region of the display unit to display time information are executed, further including:
controlling the electronic device to broadcast time.

Optionally, when or after computer instructions stored in the storage medium and corresponding to the controlling a first display region of the display unit to display a first display content are executed, further including:
determining whether the displayed first display content meets a second preset condition; and
controlling the electronic device to vibrate and/or controlling the electronic device to ring if the displayed first display content meets the second preset condition.

Optionally, when computer instructions stored in the storage medium and corresponding to the determining whether the displayed first display content meets a second preset condition are executed, further including:
determining whether the number of the events to be processed included in the first display content is greater than a preset number; and the first display content meets the second preset condition if the number of the events to be processed included in the first display content is greater than the preset number; or
determining whether any one of the events to be processed included in the first display content is an event to be processed having an interval between its occurring time instant and a current time instant less than a preset duration; and the event to be processed meets the second preset condition if any one of the events to be processed included in the first display content is the event to be processed.

Another method for processing information in an embodiment of the disclosure is applicable to an electronic device including a display unit and an image acquisition unit. The method includes: receiving a first operation performed on the electronic device by a user in the case that the display unit is in a deactive state; determining whether the first operation meets a first preset condition; and controlling the image acquisition unit to acquire an image if the first operation meets the first preset condition.

In the embodiment of the disclosure, in the case that the display unit is in the deactive state, the image acquisition unit may be directly controlled to acquire an image, if the first operation performed on the electronic device by the user is received and it is determined that the first operation meets the first preset condition. In this case, if people want to shoot some views at once after seeing the views by a mobile phone, a first operation is directly performed on the mobile phone to enable the electronic device to directly shoot; the user does not need to lighten and unlock the screen and, and it is advantageous to shoot a wonderful moment as soon as possible. According to the embodiments of the disclosure, in the case that the image acquisition unit is used to shoot, the electronic device responds quickly, and the user needs to perform less operation, thereby saving operation time and improving a user experience.

In order to illustrate the objects, the technical solutions and advantages of the embodiments of the disclosure more clearly, hereinafter the technical solutions of the embodiments of the disclosure are described clearly and completely in conjunction with the drawings of the embodiments of the disclosure. Apparently, the described embodiments are some of the embodiments of the disclosure, not all the embodiments. All of other embodiments obtained based on the embodiments of the disclosure by those skilled in the art without any creative work fall within the scope of protection of the disclosure.

In the embodiments of the disclosure, the electronic device may be a mobile phone, a tablet computer (PAD), a personal computer (PC), a smart TV, a camera and so on, which is not limited in the embodiments of the disclosure.

In addition, a term “and/or” herein is an association for describing associated objects and may indicate three types of relations. For example, A and/or B may indicate that: A exists, both A and B exist, or B exists. In addition, a character “/” herein generally indicates a relation of “or” between the prior object and the latter object associated with each other, unless particularly illustrated.

Hereinafter an embodiment of the disclosure is illustrated in detail in conjunction with the drawings.

Referring to FIG. 6, a method for processing information is provided according to an embodiment of the disclosure, applicable to an electronic device including a display unit and an image acquisition unit. The method includes step 601 to step 603.

In step 601, a first operation performed on the electronic device by a user is received in the case that the display unit is in a deactive state.

The display unit is in the deactive state, i.e., the user can not view display content in the display unit. Generally, if the user wants to start the image acquisition unit, the user needs to determine a position of an application icon corresponding to the image acquisition unit based on the display content in the display unit, and then operates the application icon to start the image acquisition unit. However, if the display unit is in the deactive state, the user can not view the application icon corresponding to the image acquisition unit and can not start the image acquisition unit by a general method.

In the embodiment of the disclosure, the first operation is not limited.

For example, the electronic device may have a preset key which may be a physical key or a virtual key. An operation for pressing the key by the user may be regarded as the first operation performed by the user.

Alternatively, the first operation is a gesture operation.

Alternatively, the first operation is a sound-controlled operation, i.e., an operation performed by sound.

Alternatively, the first operation is a clicking operation performed on the display unit. The number of the clicking is not limited in the embodiments of the disclosure, the clicking may be for example a click, a double-click or a triple-click. If the first operation is a clicking operation performed on the display unit, the first operation may be a clicking operation performed within a fixed region on the display unit, i.e., the fixed region is preset on the display unit, and the user may operate within the fixed region; or the first operation may also be a clicking operation performed at any position on the display unit.

Alternatively, the first operation is a sliding operation performed on the display unit. Similarly, if the first operation is a sliding operation performed on the display unit, the first operation may be a sliding operation performed within a fixed region on the display unit, i.e., the fixed region is preset on the display unit, and the user may operate within the fixed region; or the first operation may also be a sliding operation performed at any position on the display unit.

In step 602, it is determined whether the first operation meets a first preset condition.

After the first operation performed by the user is received, it may be determined whether the first operation meets the first preset condition.

Optionally, in an embodiment of the disclosure, the process of determining whether the first operation meets a first preset condition may include that: it is determined whether operational information corresponding to the first operation matches at least one piece of preset operational information stored in the electronic device; and the first operation meets the first preset condition if the operational information matches the at least one piece of preset operational information.

Optionally, in am embodiment of the disclosure, the process of determining whether operational information corresponding to the first operation matches at least one piece of preset operational information stored in the electronic device may include that:
it is determined whether gesture information corresponding to the first operation matches at least one piece of preset gesture information stored in the electronic device, if the first operation is a gesture operation;
it is determined whether sound information corresponding to the first operation matches at least one piece of preset sound information stored in the electronic device, if the first operation is a sound-controlled operation; or
it is determined whether clicking information corresponding to the first operation matches at least one piece of preset clicking information stored in the electronic device, if the first operation is a clicking operation performed on the display unit.

In the embodiments of the disclosure, the at least one piece of preset gesture information may be stored in the electronic device in advance; if gesture information corresponding to the gesture operation performed by the user matches one of the at least one piece of preset gesture information, it is indicated that the first operation meets the first preset condition.

Alternatively, in the embodiments of the disclosure, the at least one piece of preset sound information may be stored in the electronic device in advance; if sound information corresponding to the sound-controlled operation performed by the user matches one of the at least piece of preset sound information, it is indicated that the first operation meets the first preset condition. In the embodiment of the disclosure, two pieces of sound information being matched may indicate that contents of text information corresponding to the two pieces of sound information are matched, for example the contents of text information corresponding to the two pieces of sound information are same. Alternatively, two pieces of sound information being matched may also include that voiceprint features of the two pieces of sound information are matched for example the voiceprint features of the two pieces of sound information are same, besides including that the contents of text information corresponding to the two pieces of sound information are matched; in this way, it may be ensured that the electronic device responds in the case that an owner of the electronic device performs the first operation to the electronic device, thereby protecting privacy.

Alternatively, in the embodiment of the disclosure, the at least one piece of preset clicking information may be stored in the electronic device in advance; if clicking information corresponding to the clicking operation performed by the user matches one of the at least one piece of preset clicking information, it is indicated that the first operation meets the first preset condition. In the embodiment of the disclosure, two pieces of clicking information being matched may indicate that the numbers of clicking and clicking frequencies corresponding to the two pieces of clicking information are matched, for example clicking twice with a same frequency indicates that the two pieces of clicking information are matched. Alternatively, two pieces of clicking information being matched may further include that positions corresponding to the two pieces of clicking information are matched for example positions corresponding to the two pieces of clicking information are same, besides including that the numbers of clicking and clicking frequencies corresponding to the two pieces of clicking information are matched. The at least piece of preset clicking information may be set by the electronic device or by the user. If the at least piece of clicking information is set by the user, generally it is set by the owner of the electronic device; the owner of the electronic device certainly know where a preset position is located and the preset position is unknown for other users; although other users may also perform a clicking operation, the electronic device also determines that the operation performed by other users does not meet the first preset condition, and the subsequent operations will not be performed, thereby protecting the privacy of the owner of the electronic device.

Optionally, in the embodiment of the disclosure, the method may further include: before the first operation performed on the electronic device by a user is received, it is detected to determine that a posture of the electronic device changes from a first posture to a second posture, and it is determine whether change information corresponding to the change from the first posture to the second posture meets preset change information.

The process of the determining whether the first operation meets a first preset condition may include that: it is determined, in response to the first operation, whether the first operation meets the first preset condition, if the change information meets the preset change information.

That is to say, firstly a response is made to the first operation, and then it is determined whether the first operation meets the first preset condition. However, the electronic device responds to the first operation after determining that the change of the posture of the electronic device meets the preset change information.

Determining the posture of the electronic device may avoid influence caused by a misoperation by the user. For example, the user may perform the first operation to the electronic device inadvertently, and change information of the posture of the electronic device corresponding to the inadvertent operation generally does not meet the preset change information; by determining the posture of the electronic device, the electronic device does not respond, thereby avoiding an error response of the electronic device.

In the embodiments of the disclosure, the change information is not limited. For example, the change information may be information corresponding to a change of a centre of gravity of the electronic device.

For example, if the change information is information corresponding to the change of the center of gravity of the electronic device, the change information may include information of a moving distance of the center of gravity of the electronic device, i.e., during a process in which the electronic device changes from the first posture to the second posture, the center of gravity of the electronic device moves. Hence, the process of determining whether the change information meets the preset change information may include that: it is determined whether the moving distance of the center of gravity of the electronic device meets a preset moving distance; for example, it is determined whether the moving distance of the center of gravity of the electronic device is not less than the preset moving distance; it is determined that the moving distance of the center of gravity of the electronic device meets the preset moving distance, i.e., it is determined the change information meets the preset change information, if the moving distance of the center of gravity of the electronic device is not less than the preset moving distance.

In the embodiments of the disclosure, in the case that the electronic device is in the first posture, a position corresponding to the center of gravity of the electronic device is referred to as a first position; and in the case that the electronic device is in the second posture, a position corresponding to the center of gravity of the electronic device is referred to as a second position. Preferably, the change information may not include information corresponding to the change of the center of gravity of the electronic device, but also include a distance from the first position to the horizontal plane and a distance from the second position to the horizontal plane. Hence, the process of determining whether the change information meets the preset change information may include that: it is determine whether the moving distance of the center of gravity of the electronic device meets the preset moving distance, and it is determine whether a difference between the distance from the second position to the horizontal plane and the distance from the first position to the horizontal plane meets a preset difference. For example, the determining whether the moving distance of the center of gravity of the electronic device meets the preset moving distance may be that: it is determined whether the moving distance of the center of gravity of the electronic device is not less than the preset moving distance; and the determining whether a difference between the distance from the second position to the horizontal plane and the distance from the first position to the horizontal plane meets the preset difference may be that: it is determined that whether the difference between the distance from the second position to the horizontal plane and the distance from the first position to the horizontal plane is greater than 0. If the moving distance of the center of gravity of the electronic device is not less than the preset moving distance and the difference between the distance from the second position to the horizontal plane and the distance from the first position to the horizontal plane is greater than 0, it may be determined that the moving distance of the center of gravity of the electronic device meets the preset moving distance and the difference between the distance from the second position to the horizontal plane and the distance from the first position to the horizontal plane meets the preset difference, i.e., it may be determined that the change information meets the preset change information.

Generally, the electronic device for example the mobile phone is placed in the bag of the user or on the desk. When the user wants to shoot, the user lifts the mobile phone to shoot; in this case, the posture of the electronic device changes apparently, and generally a distance from the changed center of gravity to the horizontal plane is greater than a distance from the unchanged center of gravity to the horizontal plane. The determining for the posture may determine whether the user wants to shoot as accurately as possible, and enable the determining result to be more accurate.

Alternatively, the change information may be information corresponding to a change of an angle between the electronic device and the horizontal plane.

For example, if the change information is information corresponding to the change of the angle between the electronic device and the horizontal plane, the angle between the electronic device and the horizontal plane changes during a process in which the electronic device changes from the first posture to the second posture. For example, in the case that the electronic device is in the first posture, an angle between the electronic device and the horizontal plane is referred to as a first angle; in the case that the electronic device is in the second posture, an angle between the electronic device and the horizontal plane is referred to as a second angle. Hence, the determining whether the change information meets the preset change information may be that: it is determined whether an absolute value of a difference between the first angle and the second angle meets a preset angle difference; for example, it is determined whether the absolute value of the difference between the first angle and the second angle is not less than the preset angle difference; and it may be determined that the absolute value of the difference between the first angle and the second angle meets the preset angle difference, i.e., it may be determined that the change information meets the preset change information, if the absolute value of the difference between the first angle and the second angle is not less than the preset angle difference.

Alternatively, the change information may be other information, which is not limited here by the disclosure, as long as the change information can describe the change of the posture of the electronic device.

In step 603, the image acquisition unit is controlled to acquire an image if the first operation meets the first preset condition.

If it is determined that the first operation meets the first preset condition, the electronic device may directly control the image acquisition unit to acquire an image.

The process of electronic device controlling the image acquisition unit to acquire an image may include that: the electronic device may firstly determine whether the image acquisition unit is in the on state or the off state, if it is determined that the first operation meets the first preset condition; the electronic device may directly control the image acquisition unit to acquire an image, if it is determined that the image acquisition unit is in the on state; and the electronic device may firstly start the image acquisition unit and then control the image acquisition unit to acquire an image, if it is determined that the image acquisition unit is in the off state.

In an embodiment of the disclosure, the image acquisition unit may be a camera of the electronic device or other functional units for image acquisition, for example.

Optionally, in an embodiment of the disclosure, the method may further include: when or after the image acquisition unit is controlled to acquire an image, the display unit is controlled to be still in the deactive state or to be in an image preview state.

That is to say, if the image acquisition unit is controlled to start acquiring an image, the electronic device may control the display unit to be still in the deactive state, thereby saving power of the electronic device. Alternatively, the electronic device may also control the display unit to change from the deactive state to a lightened state and control the display unit to display the image acquired by the image acquisition unit, i.e., controlling the image acquisition unit to be in the image preview state, such that the user may view the acquired image by the display unit, thereby the user may conveniently determine whether the acquired image meets the requirement, and adjust a acquisition parameter of the image acquisition unit in a timely manner to obtain an image meeting the requirement as soon as possible.

In the embodiment of the disclosure, the electronic device may control the image acquisition unit to acquire an image or multiple images. For example, the image acquisition unit may be directly controlled to be in a burst mode and to acquire multiple images for selecting of the user, thereby it is advantageous for the user to select a met image. Alternatively, the electronic device may directly control the image acquisition unit to acquire a video. Specifically, an acquisition mode and an acquisition object of the image acquisition unit may be determined by the electronic device itself or may be set by the user in advance.

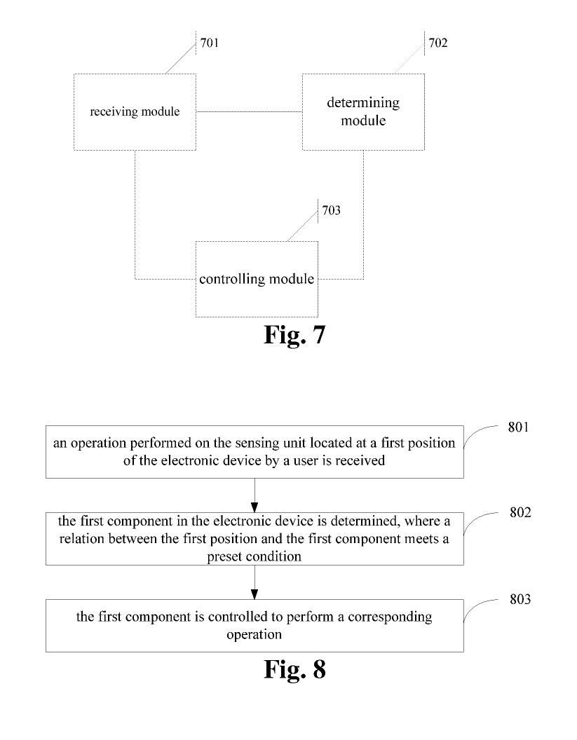

Referring to FIG. 7, based on the same concept, an electronic device including a display unit and an image acquisition unit is provided according to an embodiment of the disclosure. The electronic device further includes a receiving module 701, a determining module 702 and a controlling module 703.

The receiving module 701 is configured to receive a first operation performed on the electronic device by a user in the case that the display unit is in a deactive state.

The determining module 702 is configured to determine whether the first operation meets a first preset condition.

The controlling module 703 is configured to control the image acquisition unit to acquire an image if the first operation meets the first preset condition.

Optionally, in an embodiment of the disclosure, the controlling module 703 is further configured to control the display unit to be still in the deactive state or control the display unit to be in an image preview state, when or after controlling the image acquisition unit to acquire an image.

Optionally, in an embodiment of the disclosure, the determining module 702 is configured to determine whether operational information corresponding to the first operation matches at least one piece of preset operational information stored in the electronic device; and the determining module 702 is configured to determine that the first operation meets the first preset condition, if the operational information matches the at least one piece of preset operational information.

Optionally, in an embodiment of the disclosure, the determining module 702 is configured to:
determine whether gesture information corresponding to the first operation matches at least one piece of preset gesture information stored in the electronic device, if the first operation is a gesture operation;
determine whether sound information corresponding to the first operation matches at least one piece of preset sound information stored in the electronic device, if the first operation is a sound-controlled operation; or
determine whether clicking information corresponding to the first operation matches at least one piece of preset clicking information stored in the electronic device, if the first operation is a clicking operation performed on the display unit.

Optionally, in an embodiment of the disclosure, the electronic device may further include a detecting module configured to detect to determine that a posture of the electronic device changes from a first posture to a second posture, and determine whether change information corresponding to the change from the first posture to the second posture meets preset change information. The determining module 702 is configured to determine, in response to the first operation, whether the first operation meets the first preset condition, if the change information meets the preset change information.

Optionally, in an embodiment of the disclosure, the controlling module 703 is configured to control the image acquisition unit to acquire at least one image or control the image acquisition unit to acquire a video.

The method for processing information in the embodiments of the disclosure is applicable to an electronic device including a display unit and an image acquisition unit. The method may include: receiving a first operation performed on the electronic device by a user in the case that the display unit is in a deactive state; determining whether the first operation meets a first preset condition; and controlling the image acquisition unit to acquire an image if the first operation meets the first preset condition.

In the embodiments of the disclosure, in the case that the display unit is in the deactive state, the image acquisition unit may be directly controlled to acquire an image, if the first operation performed on the electronic device by the user is received and it is determined that the first operation meets the first preset condition. In this case, if people want to shoot some scenes at once after viewing the scenes by a mobile phone, a first operation is directly performed on the mobile phone to enable the electronic device to directly shoot; the user does not need to lighten and unlock the screen, and it is advantageous to shoot a wonderful moment as soon as possible. According to the embodiments of the disclosure, in the case that the image acquisition unit is used to shoot, the electronic device responds quickly, and the user needs to perform less operation, thereby saving the time for operation and improving a user experience.

Those skilled in the art should clearly know that the dividing for each functional module above is exemplary for convenience and conciseness. In practice, the above functions may be performed by different functional modules based on the requirement, i.e., the apparatus includes different functional modules to perform all or part of the functions described above. For the specific working process of the system, apparatus and unit described above, one may refer to a corresponding process in the preceding method embodiments, which is not described here.

In the several embodiments provided by the disclosure, it should be understood that the disclosed system, apparatus or method may be implemented by other ways. For example, the apparatus embodiments described above are schematic, the dividing for the module or the unit is based on the logical function; in practice, the module or the unit may be divided by other ways, for example multiple units or assemblies may be combined or integrated into another system, or some features may be ignored or not executed. In addition, the displayed or discussed coupling, direct coupling or communication connection may be through some interfaces, and indirect coupling or communication connection of the apparatus or unit may be electric or mechanical or the like.

Units illustrated as a separate component may be physical separated or not. A component displayed as a unit may be a physical unit or not, i.e., locating at the same location or distributing on multiple network units. Part or all of the units may be selected to realize the objects of the embodiments based on the actual requirement.

In addition, various functional units of each embodiment of the disclosure may be integrated in a processing unit, may be separated physical units or two or more units may be integrated in one unit. The integrated unit above may be implemented by hardware or a software functional unit.

In the case that the integrate unit is implemented as the software functional unit or sold or used as an independent product, the integrated unit may be stored in a computer readable storing medium. Based on such understanding, the essential parts, parts contributing to the conventional technology or part or all of the technical solutions of the disclosure may be embodied as a software product. The computer software product is stored in a storage medium and includes several instructions configured to enable a computer device (which may be personal computer, a server, or a network device or the like) or a processor to perform all of part of the steps in the methods of each embodiment of the disclosure. The preceding medium includes a USB flash disc, a mobile disc, a Read-Only Memory (ROM), a Random Access Memory (RAM), a magnetic disc or a CD-ROM or the like.

Specifically, computer instructions corresponding to a method for processing information in the embodiments of the disclosure may be stored in a storage medium for example a CD-ROM, a hard disc or a USB flash disc. When computer instructions stored in the storage medium and corresponding to an image acquisition method are read or executed by an electronic device, including:
receiving a first operation performed on the electronic device by a user in the case that the display unit is in a deactive state;
determining whether the first operation meets a first preset condition; and
controlling the image acquisition unit to acquire an image if the first operation meets the first preset condition.

Optionally, when or after computer instructions stored in the storage medium and corresponding to the controlling the image acquisition unit to acquire an image are executed, further including:
controlling the display unit to be still in the deactive state or controlling the display unit to be in an image preview state.

Optionally, when computer instructions stored in the storage medium and corresponding to the determining whether the first operation meets a first preset condition, including:
determining whether operational information corresponding to the first operation matches at least one piece of preset operational information stored in the electronic device;

and determining that the first operation meets the first preset condition if the operational information matches the at least one piece of preset operational information.

Optionally, when computer instructions stored in the storage medium and corresponding to the determining whether operational information corresponding to the first operation meets at least one piece of preset operational information stored in the electronic device are executed, including:
determining whether gesture information corresponding to the first operation matches at least one piece of preset gesture information stored in the electronic device, if the first operation is a gesture operation;
determining whether sound information corresponding to the first operation matches at least one piece of preset sound information stored in the electronic device, if the first operation is a sound-controlled operation; or
determining whether a clicking information corresponding to the first operation matches at least one piece of preset clicking information stored in the electronic device, if the first operation is a clicking operation performed on the display unit.

Optionally, before computer instructions stored in the storage medium and corresponding to the receiving a first operation performed on the electronic device by a user are executed, further including:
detecting to determine that a posture of the electronic device changes from a first posture to a second posture; and determining whether change information corresponding to the change from the first posture to the second posture matches preset change information.

Optionally, when computer instructions stored in the storage medium and corresponding to the determining whether the first operation meets a first preset condition are executed, including:
determining, in response to the first operation, whether the first operation meets the first preset condition, if the change information meets the preset change information.

Optionally, when computer instructions stored in the storage medium and corresponding to the controlling the image acquisition unit to acquire an image are executed, including:
controlling the image acquisition unit to acquire at least one image or controlling the image acquisition unit to acquire an image.

According to an embodiment of the disclosure, a method for processing information is provided, applicable to an electronic device including a sensing unit. The method may include: receiving an operation performed on the sensing unit located at a first position of the electronic device by a user; determining a first component in the electronic device, where a relation between the first position and the first component meets a preset condition; and controlling the first component to perform a corresponding operation.

In the embodiments of the disclosure, sensing units may be set around all or part of the components of the electronic device. In the case that the user performs an operation to a sensing unit, the electronic device may determine a component corresponding to the sensing unit and control the component to perform a corresponding operation. For example, in the case that the user wants to achieve a function by a certain component in the electronic device, the user does not need to search for an application corresponding to the component from multiple applications, thereby saving the time for search. In addition, the user does not even need to lighten a screen, thereby further saving the time for operation and also saving power of the electronic device. The user only needs to perform an operation for example a touching operation to a sensing unit corresponding to the component, and the electronic device may instruct the component to achieve the function. The user and the electronic device do not need perform many operations, thereby saving the time for operation and reducing operation steps, and improving a user experience.

In order to illustrate the objects, the technical solutions and advantages of the embodiments of the disclosure more clearly, hereinafter the technical solutions of the embodiments of the disclosure are described clearly and completely in conjunction with the drawings of the embodiments of the disclosure. Apparently, the described embodiments are some of the embodiments of the disclosure, not all the embodiments. All of other embodiments obtained based on the embodiments of the disclosure by those skilled in the art without any creative work fall within the scope of protection of the disclosure.

In the embodiments of the disclosure, the electronic device may be a mobile phone, a tablet computer (PAD), a personal computer (PC), a smart TV, a camera and so on, which is not limited in the disclosure.

In addition, a term “and/or” herein is an association for describing associated objects and may indicate three types of relations. For example, A and/or B may indicate that: A exists, both A and B exist, or B exists. In addition, a character “/” herein generally indicates a relation of “or” between the prior object and the latter object associated with each other, unless particularly illustrated.

Hereinafter an embodiment of the disclosure is illustrated in detail in conjunction with the drawings.

Referring to FIG. 8, a method for processing information is provided according to an embodiment of the disclosure, applicable to an electronic device including a sensing unit. The method includes step 801 to step 803.

In step 801, an operation performed on the sensing unit located at a first position of the electronic device by a user is received.

Optionally, in the embodiment of the disclosure, the sensing unit may be a sensor for example. Practically, the sensor may be of different types, for example a capacitive sensor, a pressure sensor, a proximity sensor or other sensors, which is not limited in the disclosure, as long as the sensor can sense an operation performed thereon by the user.

In the embodiment of the disclosure, the electronic device may include multiple components. Theoretically, for each component of the electronic device, a sensing unit may be set within a fixed region around the component. However, for a component completely located within a shell of the electronic device, the user may not perform an operation to the sensing unit even if the sensing unit is set around the component. Hence, for the component completely located within the shell of the electronic device, no sensing unit may be set. Alternatively, if the user wants to set the sensing unit around the component completely located within the shell of the electronic device, a sensing unit may be set at a position corresponding component, in an outer surface of the shell of the electronic device.

For example, a component of the electronic device for example a Central Processing Unit (CPU) is completely located within the shell of the electronic device.

For a component one part of which is located within the shell of the electronic device and the other part of which is located outside of the shell of the electronic device, a sensing unit may be set within a fixed region around the component; and the sensing unit may be set in an outer surface of the shell of the electronic device.

For example, for an audio output unit and an image acquisition unit of the electronic device, one part of which is located within the shell of the electronic device and the other part is located outside of the shell of the electronic device. The audio output unit is a loudspeaker for example, a speaker of which is located outside of the shell of the electronic device, and the remaining part of which is located within the shell of the electronic device. The image acquisition unit is a camera for example, a lens of which is located outside of the shell of the electronic device, and the remaining part of which is located within the shell of the electronic device.

For example, in the conventional technology, if a user wants to capture an image by the image acquisition unit, the user needs to lighten a display screen of the electronic device and even unlock the display screen; then the user searches for an application corresponding to the image acquisition unit from multiple applications displayed in the display screen and starts the application to capture an image; apparently the operation is complicated and causes time waste. However, in the embodiment of the disclosure, a sensing unit may be set within a fixed region around the image acquisition unit; the user does not need to lighten the display screen and even search for the application corresponding to the image acquisition unit from multiple applications, the user only performs an operation to the sensing unit set within the fixed region around the image acquisition unit to start the image acquisition unit, thereby the operation is simple and convenient. Particularly in some certain environment, for example the user wants to shoot at once when the user sees a wonderful view suddenly, according to the method in the conventional technology, the wonderful view may disappear and can not be shoot after the user starts the image acquisition unit; but according to the method provided by the disclosure, the user may start the image acquisition unit by only performing an operation to a corresponding sensing unit, it is advantageous for the user to capture a content of interest, thereby improving a user experience and a response speed of the electronic device.

In step 802, the first component in the electronic device is determined, where a relation between the first position and the first component meets a preset condition.

In the electronic device, for example sensing units are set around multiple components; the electronic device firstly determines that which component in the electronic device corresponds to a sensing unit performed an operation by the user, in the case that the user performs the operation to the sensing unit.

In the embodiment of the disclosure, the sensing unit may be set within a fixed region around a component. For the component, a relation between a position where the sensing unit is located and the component meets a certain condition, which is referred to as a preset condition in the embodiment of the disclosure.

Optionally, in the embodiment of the disclosure, the determining a first component in the electronic device where a relation between the first position and the first component meets a preset condition may include: determining the first component located at a second position in the electronic device, where a distance between the first position and the second position is less than a preset condition.

Specifically, the preset condition may be that: a distance between a position of the component and the first position is less than the preset distance. In the embodiment of the disclosure, since the sensing unit may be set within a fixed region around the component, for a sensing unit within the fixed region, a distance between the sensing unit and the component is less than the preset distance; for a sensing unit outside of the fixed region, a distance between the sensing unit and the component is not less than the preset distance. In this case, the electronic device may determine which component corresponds to the sensing unit performed the operation by the user, based on the preset condition.

For example, the electronic device includes three components, and sensing units are set around fixed regions around the three components. A first sensing unit is set within the fixed region around the first component; three sensing units are set within the fixed region around the second component, referred to as a second sensing unit, a third sensing unit and a fourth sensing unit respectively; and two sensing units are set within the fixed region around the third component, referred to as a fifth sensing unit and a sixth sensing unit respectively.

The user performs an operation to one of the sensing units. For example the sensing units are all capacitive sensors, and the user performs a touching operation to one capacitive sensor. The electronic device determines a position corresponding to the sensing unit for example referred to as a position 1, after receiving the operation. After determining the position 1, the electronic device may determine a component where a relation between the position 1 and the component meets the preset condition. For example, a distance between the position 1 and the first component is 2 cm, a distance between the position 1 and the second component is 5 cm, and a distance between the position 1 and the third component is 4 cm, and the preset distance is 3 cm, thereby the electronic device may determine that the position 1 corresponds to the first component, i.e., the user performs the operation to the sensing unit 1.

In the above example, for each component, the corresponding preset distance is identical, but it is exemplary and to illustrate the idea of the disclosure. In other embodiments of the disclosure, for each component, the corresponding preset distance may be different. For example for the above example, the preset distance corresponding to the first component may be 3 cm, the preset distance corresponding to the second component may be 6 cm, and the preset distance corresponding to the third component may be 4.5 cm, hence the electronic device needs to determine whether a relation between the position 1 and each component meets the preset condition corresponding to the component, after determining the position 1. The electronic device may still determine that the position 1 corresponds to the first component.

That is to say, in the embodiments of the disclosure, the corresponding component is determined based on the sensing unit, which is not limited here by the embodiments of the disclosure; and a method for determining the component corresponding to the sensing unit performed the operation by the user by other ways and without using the method for determining based on the position introduced in the embodiment of the disclosure, falls within the scope of protection of the disclosure.

In step 803, the first component is controlled to perform a corresponding operation.

In the embodiments of the disclosure, if it is determined that a component corresponding to a sensing unit performed the operation by the user is the first component, the electronic device may control the first component to perform a corresponding operation.

Optionally, in the embodiments of the disclosure, the controlling the first component to perform a corresponding operation includes: if the first component is an audio output unit, the audio output is controlled to output sound information.

In the case that it is determined that the first component is the audio output unit, the electronic device may firstly determine whether the audio output unit is in the on state or the off state. The electronic device may directly control the audio output unit to output corresponding sound information, if the audio output unit is in the on state; and the electronic device may firstly start the audio output unit and then control the audio output unit to output the corresponding sound information, if the audio output unit is in the off state.

Optionally, in the embodiments of the disclosure, the controlling the first component to perform a corresponding operation includes: if the first component is an image acquisition unit, the image acquisition unit is controlled to acquire an image.

Similarly, in the case that it is determined that the first component is the image acquisition unit, the electronic device may firstly determine whether the image acquisition unit is in the on state or the off state. The electronic device may directly control the image acquisition unit to acquire an image, if the image acquisition unit is in the on state. The electronic device may firstly start the image acquisition unit and then control the image acquisition unit to acquire an image, if the image acquisition unit is in the off state.

That is to say, the volume output from the audio output unit may be controlled based on the number of sensing units. The correspondence between the number of sensing units and a volume may be set by the electronic device, for example the correspondence may be set when the electronic device leaves the factory; or the correspondence may be set by the user, in this case the user may set the correspondence based on the requirement and it is more autonomous.

For example, four sensing units are set within a fixed region around the audio output unit, the correspondence between the number of sensing units and the volume is that: a corresponding volume is volume 1 in the case that the number of sensing units is 1; a corresponding volume is volume 2 in the case that the number of sensing units is 2; a corresponding volume is volume 3 in the case that the number of sensing units is 3; and a corresponding volume is volume 4 in the case that the number of sensing units is 4. The relation between the volumes is that: volume 4>volume 3>volume 2>volume 1, i.e., the volume 4 is the highest, and the volume 1 is the lowest.

In this case, if it is determined that the user performs an operation to two sensing units, it may be determined that the output volume from the audio output unit is the volume 2; if it is determined that the user performs an operation to three sensing units, it may be determined that the output volume from the audio output unit is the volume 3, and so on. The user may directly control the output volume based on the number of the operated sensing units without a manual adjusting, thereby further decreasing operation steps, saving the time for operation and facilitating the use for the user.

Hereinafter the method for processing information in the embodiments of the disclosure is introduced in detail by a specific example.

For example the electronic device is a mobile phone, which includes an image acquisition unit 904 and an audio output unit 905. For example, the image acquisition unit 104 is a camera 904, and the audio output unit 905 is a loudspeaker 905. As shown in FIG. 1B, for the camera 904 and the loudspeaker 905, one part of which is located within the shell of the electronic device, and the other part of which is located outside of the shell of the electronic device. For the loudspeaker 905, a speaker of which is located outside of the shell of the electronic device, and the remaining part of which is located within the shell of the electronic device. For the camera 904, a lens of which is located outside of the shell of the electronic device, and the remaining part of which is located within the shell of the electronic device.

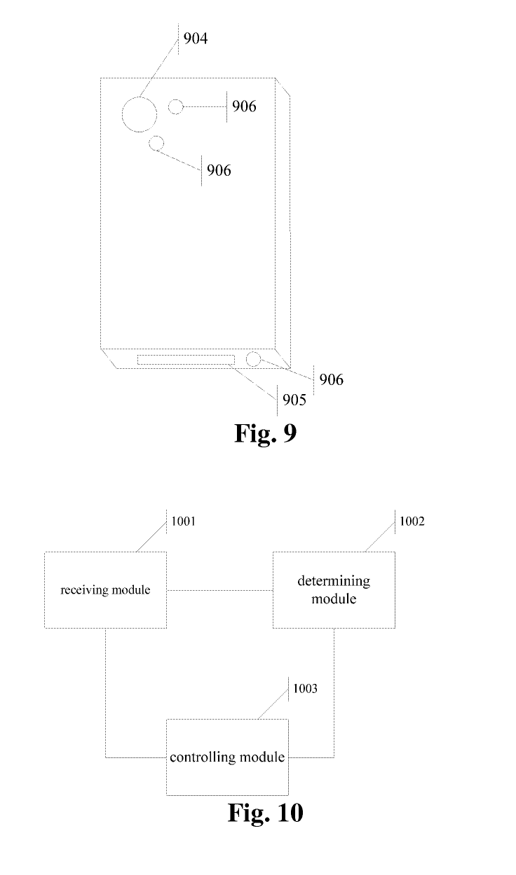

Sensing units 906 are set within a first fixed region around the camera 904, for example two sensing units 906 are set within the first fixed region, as shown in FIG. 9. A sensing unit 906 is also set within a second fixed region around the loudspeaker 905, for example one sensing unit 906 is set within the second fixed region, as shown in FIG. 9. In the embodiment, the sensing unit may be a capacitive sensor. For example, in the embodiment, the sensing units 906 are set around the camera 904 and the loudspeaker 905 in the mobile phone.

The user performs a touching operation to one capacitive sensor 906, and the electronic device may receive the operation from the user. The electronic device firstly determines a position, referred to as a first position, where the capacitive sensor 906 is located. After determining the first position, the electronic device may determine a component, where a relation between the first position and the component meets the preset condition.

Specifically, the electronic device may determine a component, where a distance between the component and the first position is less than the preset distance. In the embodiment, for example the preset distance corresponding to the camera 904 is equal to the preset distance corresponding to the loudspeaker 905, and the electronic device may determine whether a distance between the first position and a position where the camera 904 is located is less than the preset distance and whether a distance between the first position and a position where the loudspeaker 905 is located is less than the preset distance respectively.

As shown in FIG. 9, the camera 904 is located a first plane of the electronic device, which is opposite to a plane where the display unit of the electronic device is located. The loudspeaker 905 is located at a second plane of the electronic device, which is perpendicular to the first plane. The electronic device also includes a third plane perpendicular to the first plane, and a distance from the camera 904 to the second plane is greater than a distance from the camera 904 to the third plane.

For example, the distance between the first position and the camera 904 is 2 cm, the distance between the first position and the loudspeaker 905 is 6 cm, and the preset distance is 3 cm, thereby the electronic device may determine that a relation between the camera 104 and the first position meets the preset condition, and the electronic device may determine that the camera 104 is the component corresponding to the capacitive sensor 906.

Therefore, the electronic device may control the camera 904 to acquire an image.

Referring to FIG. 10, based on the same concept, an electronic device including a sensing unit is provided according to an embodiment of the disclosure. The electronic device may further include a receiving module 1001, a determining module 1002 and a controlling module 1003.

The receiving module 1001 is configured to receive an operation performed on the sensing unit located at a first position of the electronic device by a user.

The determining module 1002 is configured to determine a first component in the electronic device, where a relation between the first position and the first component meets a preset condition.

The controlling module 1003 is configured to control the first component to perform a corresponding operation.

Optionally, in the embodiment of the disclosure, the determining module 1002 is configured to determine the first component located at a second position in the electronic device, where a distance between the first position and the second position is less than a preset distance.

Optionally, in an embodiment of the disclosure, the first component is an audio output unit or an image acquisition unit.

Optionally, in an embodiment of the disclosure, the controlling module 1003 is configured to control the audio output unit to output sound information, if the first component is the audio output unit.

Optionally, in an embodiment of the disclosure, the controlling module 1003 is configured to control the image acquisition unit to acquire an image, if the first component is the image acquisition unit.

Optionally, in an embodiment of the disclosure, in the case that the number of sensing units located at the first position is greater than 1, the controlling module 1003 is configured to determine, based on a correspondence between the number of sensing units and a volume, an output volume corresponding to the number of sensing units located at the first position; and the controlling module 1003 is configured to output the sound information based on the determined output volume.

Optionally, in an embodiment of the disclosure, the sensing unit is a capacitive sensor, a pressure sensor or a proximity sensor.

According to the embodiments of the disclosure, the method for processing information is provided, applicable to the electronic device including a sensing unit. The method may include: receiving an operation performed on the sensing unit located at a first position of the electronic device; determining a first component in the electronic device, where a relation between the first position and the first component meets a preset condition; and controlling the first component to perform a corresponding operation.

In the embodiments of the disclosure, sensing units may be set around all or part of the components of the electronic device. In the case that the user performs an operation to a sensing unit, the electronic device may determine a component corresponding to the sensing unit and control the component to perform a corresponding operation. For example, in the case that the user wants to achieve a function by a certain component in the electronic device, the user does not need to search for an application corresponding to the component from multiple applications, thereby saving the time for search. In addition, the user does not even need to lighten a screen, thereby further saving the time for operation and also saving power of the electronic device. The user only needs to perform an operation for example a touching operation to a sensing unit corresponding to the component, and the electronic device may instruct the component to achieve the function. The user and the electronic device do not need perform many operations, thereby saving the time for operation and reducing operation steps, and improving a user experience.

Those skilled in the art should clearly know that the dividing for each functional module above is exemplary for convenience and conciseness. In practice, the above functions may be performed by different functional modules based on the requirement, i.e., the apparatus includes different functional modules to perform all or part of the functions described above. For the specific working process of the system, apparatus and unit described above, one may refer to a corresponding process in the preceding method embodiments, which is not described here.

In the several embodiments provided by the disclosure, it should be understood that the disclosed system, apparatus or method may be implemented by other ways. For example, the apparatus embodiments described above are schematic, the dividing for the module or the unit is based on the logical function; in practice, the module or the unit may be divided by other ways, for example multiple units or assemblies may be combined or integrated into another system, or some features may be ignored or not executed. In addition, the displayed or discussed coupling, direct coupling or communication connection may be through some interfaces, and indirect coupling or communication connection of the apparatus or unit may be electric or mechanical or the like.

Units illustrated as a separate component may be physical separated or not. A component displayed as a unit may be a physical unit or not, i.e., locating at the same location or distributing on multiple network units. Part or all of the units may be selected to realize the objects of the embodiments based on the actual requirement.

In addition, various functional units of each embodiment of the disclosure may be integrated in a processing unit, may be separated physical units or two or more units may be integrated in one unit. The integrated unit above may be implemented by hardware or a software functional unit.

In the case that the integrate unit is implemented as the software functional unit or sold or used as an independent product, the integrated unit may be stored in a computer readable storing medium. Based on such understanding, the essential parts, parts contributing to the conventional technology or part or all of the technical solutions of the disclosure may be embodied as a software product. The computer software product is stored in a storage medium and includes several instructions configured to enable a computer device (which may be personal computer, a server, or a network device or the like) or a processor to perform all of part of the steps in the methods of each embodiment of the disclosure. The preceding medium includes a USB flash disc, a mobile disc, a Read-Only Memory (ROM), a Random Access Memory (RAM), a magnetic disc or a CD-ROM or the like.

Specifically, computer program instructions corresponding to a method for processing information in the embodiment of the disclosure may be stored in a storage medium for example a CD-ROM, a hard disc or a USB flash disc. When computer program instructions stored in the storage medium and corresponding to the method for processing information are read or executed by an electronic device, including:
receiving an operation performed on a sensing unit located at a first position of the electronic device by a user;
determining a first component in the electronic device, where a relation between the first position and the first component meets a preset condition; and controlling the first component to perform a corresponding operation.

Optionally, when computer instructions stored in the storage medium and corresponding to the determining a first component in the electronic device where a relation between the first position and the first component meets a preset condition are executed, including:
determining the first component at a second position in the electronic device, where a distance between the first position and the second position is less than a preset distance.

Optionally, the first component is an audio output unit or an image acquisition unit.

Optionally, in the case that the first component is the audio output unit, when computer instructions stored in the storage medium and corresponding to the controlling the first component to perform a corresponding operation are executed, including:
controlling the audio output unit to output sound information.

Optionally, in the case that the first component is the image acquisition unit, computer instructions stored in the storage medium and corresponding to the controlling the first component to perform a corresponding operation are executed, including:

controlling the image acquisition unit to acquire an image.

Optionally, in the case that the number of sensing units located at the first position is greater than 1, when computer instructions stored in the storage medium and corresponding to the controlling the audio output unit to output sound information are executed, including:
determining, based on a correspondence between the number of sensing units and a volume, an output volume corresponding to the number of sensing units located at the first position; and
outputting the sound information based on the determined output volume.

Optionally, the sensing unit is a capacitive sensor, a pressure sensor or a proximity sensor.

The above embodiments are used to introduce the technical solutions of the disclosure in detail. The illustration to the embodiments above is to help to understand the method of the disclosure and the key idea thereof, and should not be understood as limiting to the disclosure. Changes or substitutions which may be easily conceived by those skilled in the art within the technical scope disclosed by the disclosure, fall within the scope of protection of the disclosure.

1. A method for processing information applicable to an electronic device, comprising:
receiving a first operation performed on the electronic device by a user;
determining whether the first operation meets a first preset condition; and
performing a corresponding operation according to the first operation, in the case that the first operation meets the first preset condition.

2. The method according to claim 1, wherein in the case that a display unit of the electronic device is in a deactive state, performing a corresponding operation according to the first operation, in the case that the first operation meets the first preset condition, comprises:
controlling a first display region of the display unit to display first display content, in the case that the first operation meets the first preset condition, wherein the first display content is configured to indicate an event to be processed and related to the electronic device, and an area of the first display region is less than an area of a display region of the display unit.

3. The method according to claim 2, further comprising: controlling remaining region of the display region of the display unit to be in the deactive state when or after the controlling a first display region of the display unit to display the first display content.

4. The method according to claim 2, wherein determining whether the first operation meets a first preset condition comprises: determining whether operational information corresponding to the first operation matches at least one piece of preset operational information stored in the electronic device; and it is indicated that that the first operation meets the first preset condition if the operational information matches the at least one piece of preset operational information.

5. The method according to any one of claim 1, wherein after controlling a first display region of the display unit to display first display content, the method further comprises:
determining whether the displayed first display content meets a second preset condition; and
controlling the electronic device to vibrate and/or controlling the electronic device to ring, in the case that the displayed first display content meets the second preset condition.

6. The method according to claim 5, wherein determining whether the displayed first display content meets a second preset condition comprises:
determining whether the number of the events to be processed comprised in the first display content is greater than a preset number; and it is indicated that the first display content meets the second preset condition if the number of the events to be processed comprised in the first display content is greater than the preset number; or
determining whether any one of the events to be processed comprised in the first display content is an event to be processed having an interval between its occurring time instant and a current time instant less than a preset duration; and it is indicated that the event to be processed meets the second preset condition, if any one of the events to be processed comprised in the first display content is the event to be processed.

7. The method according to claim 1, wherein in the case that a display unit of the electronic device is in a deactive state, controlling the electronic device to perform a corresponding operation according to the first operation, in the case that the first operation meets the first preset condition, comprises:
controlling an image acquisition unit of the electronic device to acquire an image in the case that the first operation meets the first preset condition.

8. The method according to claim 7, wherein before receiving the first operation performed on the electronic device by the user, the method further comprises:
performing detection to determine that a posture of the electronic device changes from a first posture to a second posture; and determining whether change information corresponding to the change from the first posture to the second posture meets preset change information.

9. The method according to claim 8, wherein determining whether the first operation meets the first preset condition comprises:
determining, in response to the first operation, whether the first operation meets the first preset condition, in the case that the change information meets the preset change information.

10. The method according to claim 1, wherein in the case that the electronic device comprises a sensing unit,
receiving a first operation performed on the electronic device by a user comprises: receiving an operation performed on the sensing unit located at a first position of the electronic device by the user;
determining whether the first operation meets a first preset condition comprises: determining a first component in the electronic device where a relation between the first position and the first component meets a preset condition; and
controlling the electronic device to perform a corresponding operation according to the first operation comprises: controlling the first component to perform the corresponding operation.

11. The method according to claim 10, wherein determining a first component in the electronic device where a relation between the first position and the first component meets a preset condition comprises:
determining the first component located at a second position in the electronic device, wherein a distance between the first position and the second position is less than a preset distance.

12. An electronic device, comprising one or more processors and memory having instructions stored thereon, the instructions, when executed by the one or more processors, cause the processors to perform operations comprising:
receiving a first operation performed on the electronic device by a user;
determining whether the first operation meets a first preset condition; and
performing a corresponding operation according to the first operation, in the case that the first operation meets the first preset condition.

13. The electronic device according to claim 12, wherein in the case that a display unit of the electronic device is in a deactive state, the processors performing operations comprising:
controlling a first display region of the display unit to display first display content, in the case that the first operation meets the first preset condition, wherein the first display content is configured to indicate an event to be processed and related to the electronic device, and an area of the first display region is less than an area of a display region of the display unit.

14. The electronic device according to claim 13, the processors further perform operation comprising:
controlling remaining region of the display region of the display unit to be in the deactive state when or after the controlling a first display region of the display unit to display the first display content.

15. The electronic device according to claim 12, wherein in the case that a display unit of the electronic device is in a deactive state, the processors performing operations comprising:
controlling an image acquisition unit of the electronic device to acquire an image in the case that the first operation meets the first preset condition.

16. The electronic device according claim 15, the processors further perform the operation comprising:
performing detection to determine that a posture of the electronic device changes from a first posture to a second posture; and determining whether change information corresponding to the change from the first posture to the second posture meets preset change information.

17. The electronic device according to claim 16, the processor perform operations comprising:
determining, in response to the first operation, whether the first operation meets the first preset condition, in the case that the change information meets the preset change information.

18. The electronic device according to claim 12, wherein in the case that the electronic device comprises a sensing unit, the processors perform operations comprising:
receiving an operation performed on the sensing unit located at a first position of the electronic device by the user;
determining a first component in the electronic device where a relation between the first position and the first component meets a preset condition and
controlling the first component to perform the corresponding operation.
